(19) United States
(12) Patent Application Publication
(10) Pub. No.: US 2004/0108003 A1
(43) Pub. Date: Jun. 10, 2004

(54) Distribution device for thick matter, especially for concrete

(76) Inventors: Friedrich Schwing, Gelsenkirchen (DE); Horst Heckmann, Sprockhovel (DE)

Correspondence Address: VAN OPHEM & VANOPHEM, PC, 51543 VAN DYKE, SUITE 103, SHELBY TOWNSHIP, MI, 48317-4447, US

(21) Appl. No.: 10/467,787

(22) PCT Filed: Feb. 7, 2002
(86) PCT No.: PCT/EP02/01290

(30) Foreign Application Priority Data
Feb. 12, 2001 (DE) 10106427.6

(51) Int. Cl. G05D 7/00

(52) U.S. Cl. 137/615

(57) ABSTRACT

A distribution device for dense substances, especially concrete, with a distribution boom carrying a concrete-conveyance conduit, with at least one telescopic boom section (4) consisting of a first telescope component and a second telescope component (6) that can be extended with respect to this first component, as well as at least one reinforcement beam that is arranged on one of the telescope components and carries a section of the concrete-conveyance conduit, wherein a section of the concrete-conveyance conduit in the region of the telescopic boom section consists of a flexible hose with a compensation loop to accommodate the extension movement of the telescope or of at least one scissor-type conduit assembly made up of swivel elements connected to each other in such a manner that the swivel elements in the two terminal positions of the telescopic boom section are substantially arranged in a crossover position and, together with the articulated joints that interconnect them, move past each other during the extension and retraction of the telescopic boom section, is characterized in that the reinforcement beam that carries a section of the concrete-conveyance conduit in the region of the telescopic boom section has one of its ends connected to the extensible (second) telescope component and its other end connected to the relatively immobile (first) telescope component.

The invention relates to a distribution device in accordance with the preamble of claim 1 attached hereto.

Such distribution devices are known (EP 432 854 and WO 00/24988). They are provided with a telescopic boom section that is flexibly jointed to a slewing track ring for the distributor and by means of a hydraulic cylinder unit can be swivelled from a horizontal transport or rest position up to a substantially vertical working position. By means of this slewing track ring the distribution boom is mounted on an appropriate means of transport, possibly a motor lorry or crane truck. These distribution booms serve to carry conduits, especially for the conveyance of concrete, and are used for the most part for the distribution of concrete for the production of ceiling slabs of buildings and the like. To this end the concrete-conveyance conduit is carried by the telescopic section of the distribution boom and therefore has to adjust to the boom as it is extended. For this purpose there are known scissor-type conveyance conduits made up of swivelling elements connected to each other by means of articulated joints. When the telescopic section of the boom is extended, these conduit elements are swivelled in the manner of scissors, so that the conveyance-conduit elements with their articulated joints move past each other, after which the conveyance conduit can follow the telescopic movement.

In the case of the distribution device in accordance with EP 432 854 B1 both the relatively immobile section of the telescope and the section that moves with respect thereto are provided with a reinforcement beam to which there are attached, respectively, the part of the concrete-conveyance conduit that leads to the telescope and the part that leads away from it. This leads to a comparatively large, heavy and space-consuming structure of the telescopic section of the boom and the extensible part of the telescope, which carries the follow-up sections of the conveyance conduit, becomes subjected to considerable forces, especially when high pumping pressures occur during operation or on the occasion of substantial pumping strokes when the pumping head changes and this, in turn, calls for an appropriately massive construction of the telescope. In the case of the distribution boom in accordance with WO 00/24988, on the other hand, the articulated concrete-conveyance conduit is attached to the telescopic section of the boom by means of bearing block and this again calls for a generous design of the side of the boom.

The invention sets itself the task of providing a distribution device with a telescopic boom section that has a compact structure and a good load distribution and distinguishes itself by considerable stability.

According to the invention, this task is solved by the characteristics contained in the characterizing part of claim 1, while advantageous further developments and embodiments of the invention are specified by the characterizing features of the dependent claims.

According to the invention, in the region of the telescopic section of the boom there is provided a reinforcement beam that carries the concrete-conveyance conduit and joins the two telescopic parts to each other and for this purpose has one of its ends attached to the extensible part of the telescope and the other end attached to the part that remains relatively immobile, i.e. it couples the two telescopic parts with each other, and this both in the transport position and in the various intermediate positions that are reached by appropriate extensions of the extensible part of the telescope and define the working positions. In the extended position of the telescope this assures a very good introduction of the force into both parts of the telescope, and this is advantageous for the desired stable structure of the distribution device. At the same time it also leads to a simplification and reduction of the previous construction effort. For the purposes of a good force and moment distribution, as also for the purposes of saving space, it is particularly advantageous if the concrete-conveyance conduit in the region of the telescopic section can be arranged on both sides of the boom, that is to say, if the part of the concrete-conveyance conduit that leads to the telescope is arranged on one side of the boom, while the scissor-type assembly and the part of the concrete-conveyance conduit that leads away from the telescope and to the tip of the boom is arranged on the other side. This assures a very good force compensation. The fact that the reinforcement beam is guided in an elongated guide rail attached to the relatively immobile part of the telescope and is pinned to the extensible part of the telescope assures an unconstrained guidance of the reinforcement beam that carries the concrete-conveyance conduit the while the telescope performs its extension movement. To this end it is advantageous if the reinforcement beam is designed to resists both bending and torsion, especially when it is designed as a hollow section. The fact that both ends of the reinforcement beam are attached to the telescopic parts by means of swivel joints also assures a very good reception of the load and transfer of the force.

Particularly in the case where the concrete-conveyance conduit is arranged on both sides of the boom in the region of its telescopic section, it will be advantageous if the swivelling elements of the scissor-type assembly will be designed either as an S or as a C.

The articulation points of the scissor-type assembly, i.e. the joints at which the ends of the scissor-type assembly are connected to the sections of the concrete-conveyance conduit that, respectively, lead to and away from it and where the swivelling elements of the assembly are connected to each other, are advantageously designed as swivelling pipe joints capable of resisting bending, which constitutes an advantage in view of the pumping thrusts that occur during working process whenever there is a change of the pumping head. This once again contributes to a stable design of the distribution device.

In an advantageous further development [of the invention] the hydraulic cylinder for the folding section of the boom connected by means of an articulated joint to the telescopic section is flexibly jointed by means of a conventional articulated linkage in the region of the leading end of the extensible part of the telescope, while its other end is firmly attached to the folding section of the boom, which has the advantage that maximum use ids made of the extension path, especially that it is not reduced by the full length of the hydraulic cylinder, as is the case in conventional construction techniques, because there the hydraulic cylinder is normally articulated to the previous section of the boom. Owing to this further development of the invention, the outer part of the telescope can be pulled back as far as the articulate linkage when the telescope is retracted into its final position. We are here concerned with an advantageous further development, but also with a superordinate inventive principle in its own right that is independent of the reinforcement beam arrangement between the two telescopic boom components and can be advantageously employed also in other conditions.

Lastly, it will be advantageous if the other conduits and hosepipes—for example hydraulic conduits and hoses, electric cables and the like—needed to assure energy supplies are bundled and, in the region of the telescopic section of the boom, are then led as a bundle along the course of the scissor-type assembly of the concrete-conveyance conduit and attached thereto with appropriate means. In this connection it will be particularly advantageous if the supply bundle is protectively accommodated inside the hollow section of the reinforcement beam.

A further advantage is constituted by the telescopic boom section in combination with further boom sections that are articulated to it and can be folded, because this confers better slip-in properties upon the distribution boom, i.e. it makes it easier to pass the tip of the boom through windows or other wall openings. As a consequence, the distribution boom also becomes particularly advantageous for employment on construction sites where the available working height is limited, use inside halls being a case in point.

A preferred embodiment of the invention will now be described with the help of the drawings. The drawings, all of which are purely schematic, are as follows:

FIG. 1 shows a view of an embodiment of the distribution boom in accordance with the invention in the working position with fully extended and unfolded boom sections,

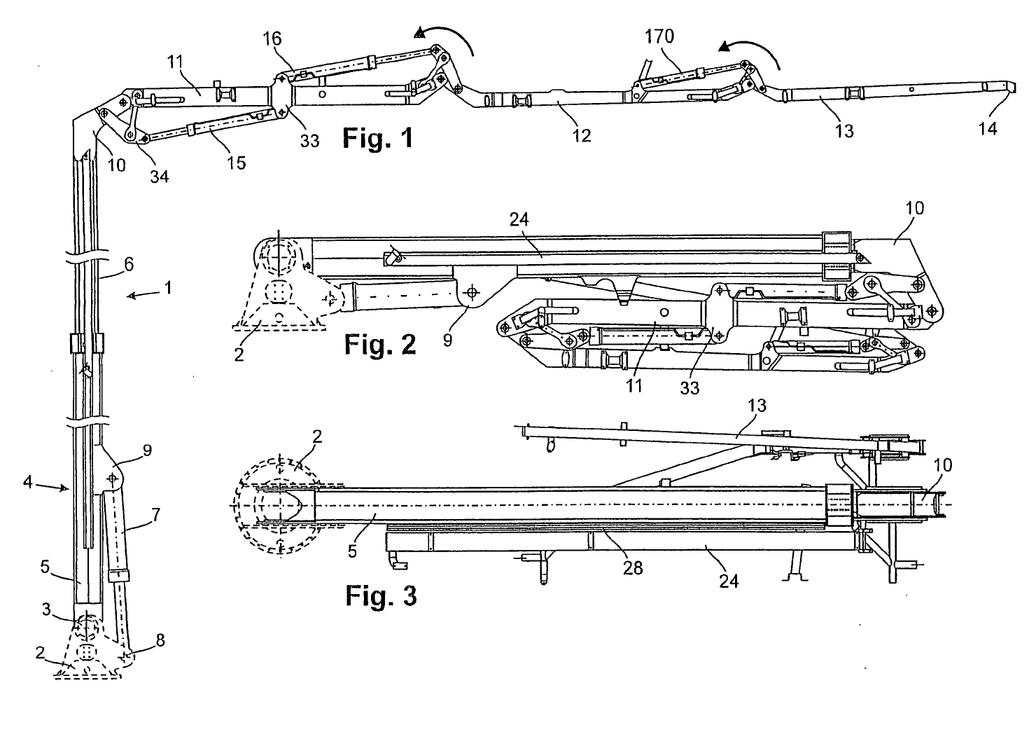

FIG. 2 shows a view the distribution boom shown in FIG. 1 in the transport position, i.e. with the boom sections in their back-folded position,

FIG. 3 shows the distribution boom of FIG. 2 as seen from above,

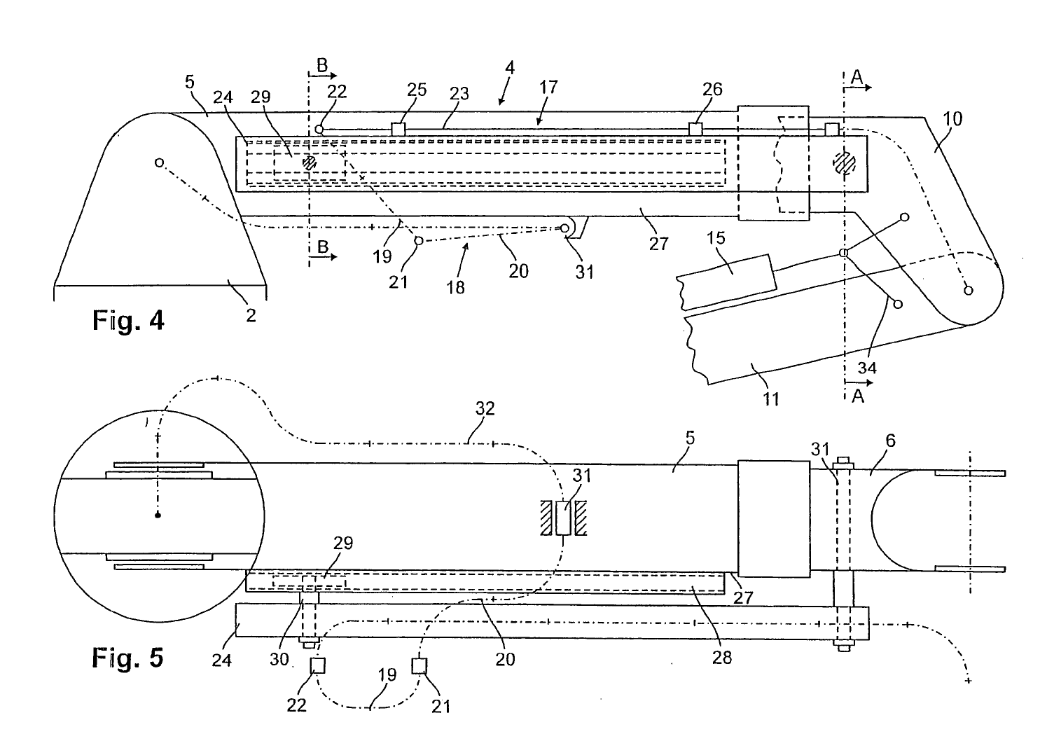

FIG. 4 shows a schematic representation of the telescopic boom section of a distribution boom as illustrated by FIGS. 1 to 3,

FIG. 5 shows the distribution boom in accordance with FIG. 4 as seen from above,

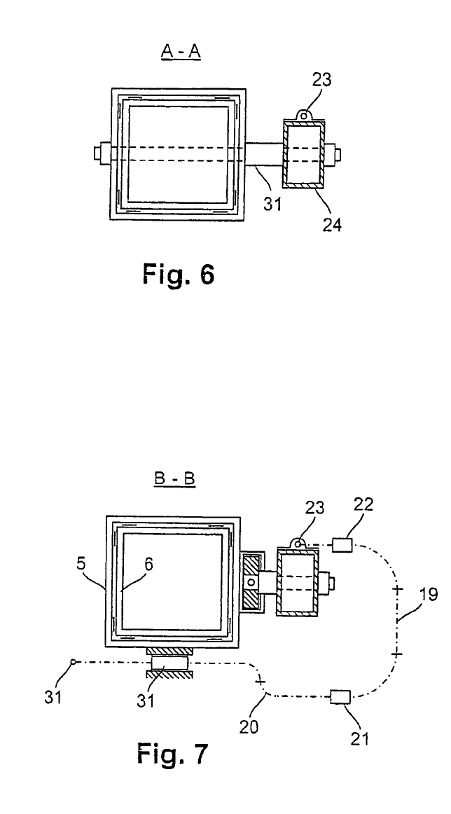

FIG. 6 shows a cross section along the line A-A of FIG. 4,

FIG. 7 shows a cross section along the line B-B of FIG. 4,

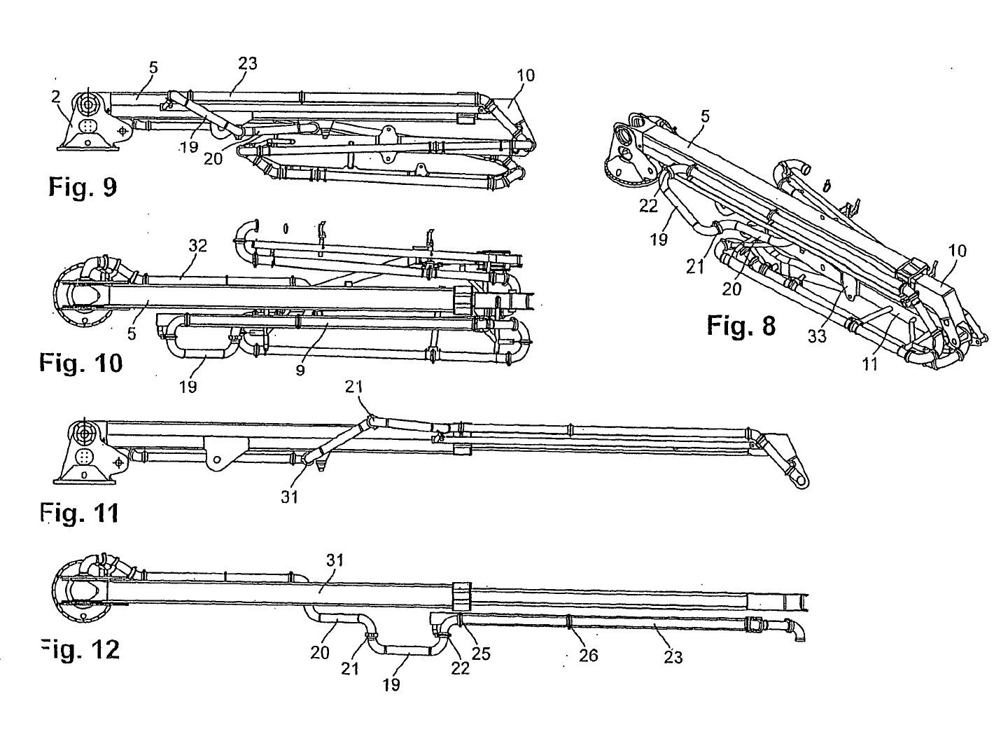

FIG. 8 shows a partial representation of a distribution boom to illustrate the concrete-conveyance conduit,

FIG. 9 shows a view of the distribution boom of FIG. 8 in its retracted position,

FIG. 10 shows the distribution boom illustrated by FIG. 5 as seen from above,

FIG. 11 shows a view of the distribution boom illustrated by FIG. 9 with the telescope in its extended position,

FIG. 12 shows the distribution boom of FIG. 11 as seen from above,

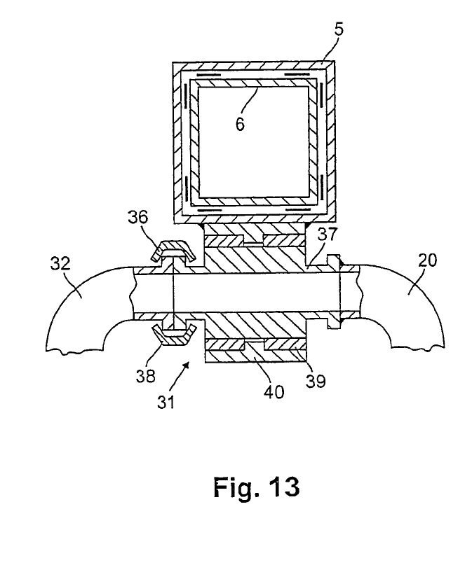

FIG. 13 shows a schematic section through an articulated joint of the scissor-type concrete-conduit assembly designed as a swivelling pipe bearing, and

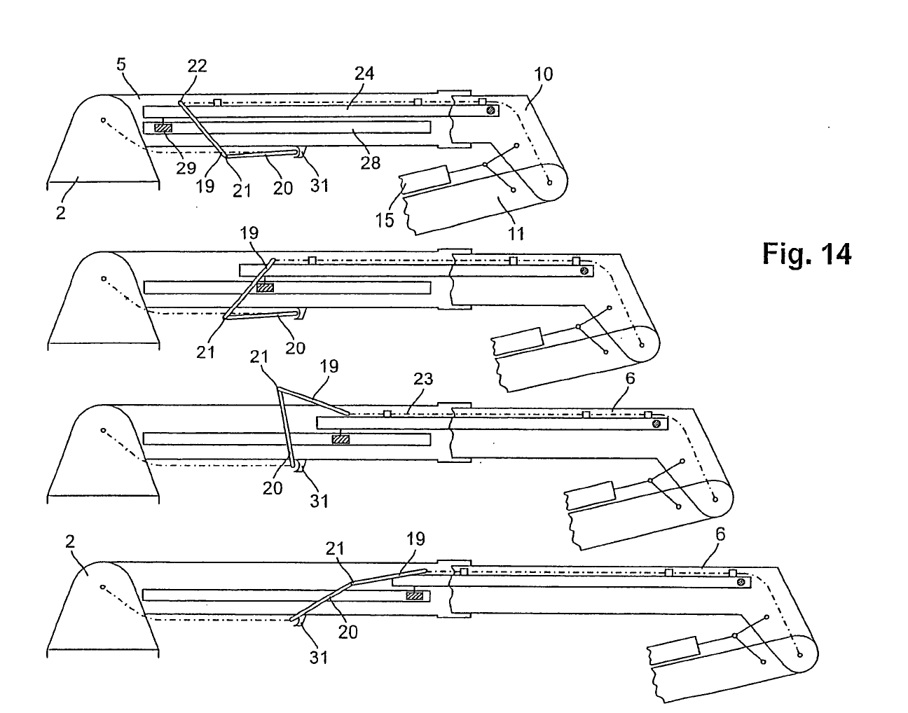

FIG. 14 shows a schematic side elevation of the telescopic boom section in various extended positions.

Together with its slewing track ring 2, the distribution boom 1 illustrated by FIGS. 1 to 3 is usually mounted on a motorized base, possibly a motor lorry or a mobile crane truck, but in case of need may also be erected in fixed position. The illustrated distribution boom is provided with a telescopic section 4 that is here articulated to the slewing track ring 2 at the position 4 and consists of a first and immobile or outer telescopic component 5 and a second or inner telescopic component 6 that can move inside the first. By means of a hydraulic cylinder 7, the telescopic boom section 4 can be swivelled through an angle of up to 90° from a horizontal transport position illustrated by FIG. 2 into a working position as illustrated by FIG. 1. For this purpose the hydraulic cylinder 7 is articulated to a bracket 8 that projects from the slewing track ring 2 and has its other end articulated to a bracket 9 arranged on the outer telescope component 5. The upper end of the extensible telescope component 6, which points in the direction of the tip of the distribution boom, is provided with an angle bracket 10 and to this there is articulated a further and foldable section 11 of the boom. This section carries yet another boom section 12 and this, in its turn, carries a third foldable boom section 13 that, as it were, constitutes the boom tip, all joints being appropriately articulated. To these mobile boom sections 5-13 there is attached, in particular, the concrete-conveyance conduit, which is not shown in FIGS. 1 to 3 in order to simplify the illustrations. This concrete-conveyance conduit terminates with a flexible spout at the boom tip 14 and, when the distribution boom is appropriately extended and swivelled, can be moved into any desired working position to distribute the conveyed concrete.

In the illustrated embodiment, which in FIG. 1 is provided with the hydraulic cylinders 15, 16 and 17 for the foldable boom sections 11 to 13, the boom sections 11 and 12 are folded by means of a so-called Z-fold, while the outermost boom section 13 can be folded back by means of a so-called rolling fold. This folding is illustrated by FIG. 2. In greater detail, when the distribution boom is to be brought into the transport position illustrated by FIG. 2, the boom section 11 is swivelled by means of the hydraulic cylinder 15 in the direction of the arrow shown in FIG. 1, while the boom sections 12 and 13 are swivelled in the direction indicated by the arrows. The illustrations of FIGS. 1 to 3 bring out the fact that, if a compact structure is to be obtained, all the moving parts have to be carefully matched to each other, especially that an arrangement of the concrete-conveyance conduit that is described in greater detail by the subsequent figures is well suited for this purpose.

To this end FIGS. 4 and 5, both of which are schematic representations, show the telescopic boom section 4, here mounted on the slew track ring 2, where the dash-dotted and partly continuous line 17 indicates the concrete-conveyance conduit. The concrete-conveyance conduit is usually made up of pipes joined together in the manner of a pipeline, but may also be constituted either wholly or in part by a hosepipe. The concrete-conveyance conduit 17 is attached by means of a flange connection in the region of the slewing track ring 2, so that it can be supplied by means of a concrete pump, in most case a twin-cylinder pump, for dense substances, especially concrete, that is usually likewise mounted on the motor lorry or a crane truck. With a view to compensating the telescopic movement of the telescopic boom section 4 due to an extension of the second telescope component 6, a scissor-type conduit assembly is provided in the region of the telescopic boom section, here generically indicated by the reference number 18, which in this case consists of a swivel element 19 and a second swivel element 20. The two swivel elements 19 at 20 are connected to each other by means of an articulated joint at 21. Furthermore, another articulated joint 22 connects the swivel element 19 to the section 23 of the concrete-conveyance conduit 17 that leads away from the scissor assembly. This section 23 of the concrete-conveyance conduit leading away from the scissors is attached to a reinforcement beam 24 and, more precisely, to the top surface of this beam, as can be seen in FIG. 5. The points at which the conduit is attached are indicated by 25 and 26.

In this case the reinforcement beam 24 is arranged on the side of the relatively immobile telescope component 5 and, more particularly, in such a manner as to enable it to slide along it. To this end an elongated guide rail 28, indicated in FIGS. 4 and 5 by means of a broken line, is arranged on the side face of the telescope component 5. As can be seen from FIG. 7, this longitudinal guide rail 28 is provided with a dovetail-shaped groove in which the reinforcement beam is guided by means of a slider indicated by 29. The place of this sliding bearing could also be taken by a bearing in the form of a roll or the like. In any case, the slider 29 is advantageously connected to the reinforcement beam by means of a fulcrum pin 30.

At its other end the reinforcement beam 24 is connected to the extensible inner telescope component 6 and, more precisely, by means of a swivel pin indicated by 31. The fact that the reinforcement beam 24 is flexibly attached to the boom via, respectively, the fulcrum pin 30 and the swivel pin 31 means that, when the inner telescope component 6 is extended, the reinforcement beam 24 will be dragged along with it and, consequently, also the concrete-conveyance conduit section 23 carried on the reinforcement beam 24. This is accompanied by the movement of the two swivel elements 19 and 20, inasmuch as the swivel element 19, given the articulated joint at 22, will be swivelled in the clockwise direction as the telescope component 6 is extended, while the swivel element 20, being articulated to the swivel element 19, will be swivelled in the anticlockwise direction, since this swivel element 20 is connected by means of an articulated joint to the underside of the relatively immobile boom section 5. The section of the concrete-conveyance conduit that leads from the slewing track ring 2 to the articulated joint 31 is indicated by 32. At the joint 31 this section is connected to the swivel element 20. These conditions are also illustrated rather clearly by FIG. 7, This figure further shows that the swivel element 20 is designed in the form of an S while the swivel element 19 is designed in the form of a C. This is of advantage for a constructionally compact arrangement of the carried concrete-conveyance conduit. The two arms of the C of the swivel element 19 terminate at the articulated joints 21 and 22, while the ends of the S-shaped swivel element 20 terminate at the articulated joints 21 and 31. When the telescope component 6 is extended, the swivel elements of the scissor-type assembly 18 are swivelled in such a manner that the articulated joints perform a crossover motion past each other, so that the concrete-conveyance conduit in the region of the telescopic boom section can follow the extension movement of the telescope. This is illustrated rather clearly by FIG. 14, which shows the various working positions reached during the extension of the inner telescope component (6). It can be seen that the concrete-conveyance conduit in the region of the scissor-type assembly is made to follow the boom by virtue of the fact that the articulated joints (21, 22 and 31) move past each other during the extension. As an alternative to the scissor-type assembly, however, it would also be possible to use a hosepipe with an appropriate compensation loop, by means of which the telescope motion could be followed as the inner component is extended outwards. These conditions, however, are not illustrated by the drawings.

With a view to assuring constructional compactness and also proper compensation of forces and moments, the section 32 of the concrete-conveyance conduit that leads to the scissor assembly is arranged, as can best be seen from FIG. 5, on the side of the first telescope component 5 opposite the one to which the reinforcement beam 24 is attached. In the region of the telescopic boom section the concrete-conveyance conduit is therefore arranged on both sides of the boom section 4.

The articulated joints 21, 22 and 31 of the scissor-type assembly are designed as swivelling pipe connection capable of resisting bending, as is schematically indicated in FIG. 7 for the case of joint 31. For this purpose the ends of the conduits adjacent to the joint may be pivotably accommodated in a bushing. To this end, however, the ends of the conduit are stiffened by means of a sleeve attached by means of welding or in some other way. FIG. 13, which relates to the joint 31 situated on the underside of the telescope component 5, shows a suitable embodiment of such a pivotable conduit bearing. In this case the end of the incoming concrete-conveyance conduit 32 is designed as a flange at 36 and connects with a corresponding bearing conduit 37 that terminates with flanges on both sides, the coupling being obtained with the help of a muff 38, here indicated only schematically. The bearing conduit 37, together with the bearing elements 39, is accommodated in a bushing 40 that is attached to the telescope component 5, preferably by means of welding. On the right-hand side can be seen the end of the S-shaped scissor element 20. which is here welded to the corresponding flange of the bearing conduit 37.

Lastly, it can be seen from FIGS. 1 and 4, that the hydraulic cylinder 15 has its piston-side end attached by means of an articulated joint to the leading end of the telescope component 6, i.e. the end that faces the tip of the distribution boom, or, more precisely, to the angle bracket 10. Though the intermediate joints are indicated only schematically in FIG. 5, they are shown in greater detail in FIG. 1. The cylinder side of the hydraulic cylinder 15 is articulated to the subsequent boom section 11 and, more precisely, as can be seen from FIG. 1, to the transverse bracket 33 more or less in the region of the middle of the boom. Due to this particular arrangement of the hydraulic cylinder 15 that differs from the conventional arrangement (in which the hydraulic cylinder would have one of its ends attached to the articulated linkage 34 and its other end attached to the boom section preceding the joint, in this particular case the inner telescope component 6), the possible throw of the telescopic section of the boom becomes enlarged, whereas in the conventional design it would be reduced by more or less the full length of the hydraulic cylinder. The illustrated arrangement therefore makes it possible to gain a corresponding telescope extension, because the outer telescope component 5 can be brought right up to the articulated linkage 34 when the inner telescope component is retracted into it end position.

The actual layout of the concrete-conveyance conduit 17 is brought out more clearly by FIGS. 8 to 12. FIGS. 9 and 10, as also the perspective view of FIG. 8, show the distribution boom in the position in which the boom sections are folded back, whereas FIGS. 11 and 12, which show the telescopic section of the boom without the other boom sections, illustrate it in the fully extended position. The respectively S- and C-shaped swivel elements 19 and 20 can be seen very clearly in FIG. 12. In this connection it should be noted that, with a view to rendering FIGS. 8 to 12 more readily comprehensible, certain details have been omitted, including, in particular, the reinforcement beam 24, which is attached to the side of the relatively immobile part of the boom, i.e. the telescope component 5, and carries the concrete-conveyance conduit and therefore assures an unconstrained guidance. Examining FIG. 1, in particular, one notes that, due to the fact that the telescopic boom section 4 is coupled to the slewing tract ring 2 and that the other boom section are attached to the telescopic boom section by means of articulated joints, this distribution boom is particularly suitable for construction sites where the unobstructed working height is limited, since this structural arrangement gives rise to very good slip-in properties, which make it possible for the boom tip to be very readily introduced into windows or other openings in the walls in order to gain access to the interior spaces. Given the stepless adjustability of the telescopic boom section, the boom can be made to bear against building edges with millimetric precision.

As can best be seen from FIGS. 6 and 7, the two telescope components 5 and 6 are designed as box sections having a substantially rectangular cross section. The reinforcement beam 24 is likewise designed as a box section, i.e. as a fully closed hollow section, and the shape of the cross section is again substantially rectangular.

The other supply lines, which include hydraulic hoses, electric cables and pipes, are bundled and therefore constitute a supply bundle that can readily be made to follow a course corresponding to the scissor-type assembly alongside the elements of the concrete-conveyance conduit and be appropriately attached thereto.

1. A distribution device for dense substances, especially concrete, with a distribution boom (1) carrying a concrete-conveyance conduit (17), with at least one telescopic boom section (4) consisting of a first telescope component (5) and a second telescope component (6; that can be extended with respect to said first component, as well as at least one reinforcement beam (24) that is arranged on one of the telescope components and carries a section of the concrete-conveyance conduit, wherein a section of the concrete-conveyance conduit in the region of the telescopic boom section consists of a flexible hose with a compensation loop to accommodate the extension movement of the telescope or of at least one scissor-type conduit assembly (18) made up of swivel elements (19, 20) connected to each other in such a manner that the swivel elements in the two terminal positions of the telescopic boom section (4) are substantially arranged in a crossover position and, together with the articulated joints (21, 22) that interconnect them, move past each other during the extension and retraction of the telescopic boom section, characterized in that the reinforcement beam (24) that carries a section of the concrete-conveyance conduit in the region of the telescopic boom section (4) has one of its ends connected to the second (extensible) telescope component (6) and its other end connected to the (first) telescope component (5) that is relative immobile with respect to said second component.

2. A distribution boom in accordance with claim 1, characterized in that the reinforcement beam (24) has its leading end firmly attached to the extensible telescope component in a fixed position, especially by means of an articulated joint, and its trailing end attached to immobile telescope component (5) in such a manner as to be able to slide in a guide along it.

3. A device in accordance with claim 1 or claim 2, characterized in that the reinforcement beam is guided on the side of the relatively immobile (first) telescope component (5) and in a longitudinal guide (28) attached to said telescope component.

4. A device in accordance with claim 3, characterized in that the reinforcement beam is guided by means of at least one guide roller or slider in the longitudinal guide designed as a guide rail with a dovetail-shaped groove.

5. A device in accordance with any one of the preceding claims, characterized in that the reinforcement beam (24) is made of a section, especially a hollow section, capable of resisting both bending and torsion.

6. A device in accordance with any one of the preceding claims, characterized in that the section (23) of the concrete-conveyance conduit that is connected to the scissor-type conduit assembly or the flexible hosepipe and/or leads away therefrom is arranged on the reinforcement beam (24).

7. A device in accordance with claim 6, characterized in that the section (24) of the concrete-conveyance conduit is arranged on the top surface of the reinforcement beam (24).

8. A device in accordance with any one of the preceding claims, characterized in that the scissor-type conduit assembly consisting of two swivel elements (19, 20) or the flexible hose have one end connected to a swivelling bearing (31) attached to the immobile telescope component and the other end connected by means of an articulated joint to the section (23) of the concrete-conveyance conduit carried on the reinforcement beam.

9. A device in accordance with claim 8, characterized in that the articulation points (22, 31) of the scissor-type conduit assembly (18), inclusive of the articulation point (21) that connects the two swivel elements (19, 20), consist of swivelling pipe connections capable of resisting bending.

10. A device in accordance with claim 8 or claim 9, characterized in that the scissor-type conduit assembly consists of a c-shaped swivel element (19) and an S-shaped swivel element (20).

11. A device in accordance with any one of the preceding claims, characterized in that the section of the concrete-conveyance conduit (17) that leads to the scissor-type conduit assembly or the flexible hosepipe is arranged on the side of the telescopic boom section that is opposite to the side that carries the reinforcement beam (24) and the section (23) of the concrete-conveyance conduit that leads away from the scissor-type conduit assembly or the flexible hose.

12. A device in accordance with claim 11, characterized in that the connection of the scissor-type conduit assembly (18) to the section (32) of the concrete-conveyance conduit that leads to it is constituted by the S-shaped swivel element (20).

13. A device in accordance with any one of the preceding claims, characterized in that the reinforcement beam (24) has its leading end, i.e. the end facing the tip of the boom, connected by means of a pin (31) to the end of the extensible telescope component (6) that likewise faces the boom tip.

14. A device with at least one boom section that is flexibly connected by means of a articulated linkage to the extensible telescope component and can be folded forward or backward by means of a hydraulic cylinder, characterized in that the hydraulic cylinder (15) for the articulated and foldable boom section (11) has its ends connected and especially articulated to, respectively, the end of the extensible telescope component (6) that faces the boom tip and the foldable boom section (15), where the hydraulic cylinder (15) has its fixed bearing point pivotably attached to the foldable boom section (11) and its other end connected by means of a conventional articulated linkage to the end of the extensible telescope component (6) that faces the boom tip.

15. A device in accordance with claim 14, characterized in that the hydraulic cylinder (15) is attached to a transverse bracket (33) arranged more or less in the middle of the foldable boom section (11) and that the hydraulic cylinder (16) for the adjacent further foldable boom section (12) is likewise articulated to said bracket.

16. A device in accordance with any one of the preceding claims, characterized in that the telescopic boom section (4) is followed by the boom sections (11, 12) for a Z-fold and at least one further boom section (13) for a roll fold.

17. A device in accordance with any one of the preceding claims, characterized in that in the region of the telescopic boom section (4) the energy supply lines, especially hydraulic pipes, hoses, electric cables and the like, are bundled and made to follow a course corresponding to the scissor-type assembly alongside the elements of the concrete-conveyance conduit and area attached thereto.

18. A device in accordance with claim 14, characterized in that in the region of the telescopic boom section the supply bundle is carried within the hollow section of the reinforcement beam (24).
